(19) United States
(12) Patent Application Publication
(10) Pub. No.: US 2025/0096514 A1
(43) Pub. Date: Mar. 20, 2025

(54) CONDUCTOR CONNECTION TERMINAL

(71) Applicant: WAGO Verwaltungsgesellschaft mbH, Minden (DE)

(72) Inventor: Tobias DYCK, Rahden (DE)

(73) Assignee: WAGO Verwaltungsgesellschaft mbH, Minden (DE)

(21) Appl. No.: 18/885,535

(22) Filed: Sep. 13, 2024

(30) Foreign Application Priority Data
Sep. 14, 2023 (DE) 20 2023 105 331.9

(51) Int. Cl. H01R 35/02; H01R 4/48; H01R 13/11; H01R 13/502

(52) U.S. Cl. CPC H01R 35/02; H01R 4/485; H01R 13/11; H01R 13/502

(57) ABSTRACT

A conductor connection terminal for connecting electrical conductors to each other, having an insulating material housing, which has a first housing section with a first spring-loaded clamping connection arranged in the first housing section, and a second housing section with a second spring-loaded clamping connection arranged in the second housing section. The first housing section can be swiveled relative to the second housing section and the conductor connection terminal has a busbar structure or the electrically conductive connection of the first spring-loaded clamping connection to the second spring-loaded clamping connection. The busbar structure has a first connection section assigned to the first spring-loaded clamping connection and a second connection section assigned to the second spring-loaded clamping connection. A hinged section connects the first connection section with the second connection section.

This nonprovisional application claims priority under 35 U.S.C. § 119(a) to German Patent Application No. 20 2023 105 331.9, which was filed in Germany on Sep. 14, 2023, and which is herein incorporated by reference.

### BACKGROUND OF THE INVENTION

### Field of the Invention

The invention relates to a conductor connection terminal for connecting electrical conductors to each other, with an insulating material housing, which has a first housing section with a first spring-loaded clamping connection arranged in the first housing section, and a second housing section with a second spring-loaded clamp connection arranged in the second housing section.

### Description of the Background Art

In conductor connection technology, conductor connection terminals are known for connecting electrical conductors to each other. For example, conductor connection terminals can be designed as feedthrough connectors. Feedthrough connectors can connect two electrical conductors that are connected to the conductor connection terminal, for example, which can have a flexible pipe run in particular.

Especially in confined installation environments, it may be desirable to provide compact conductor connection terminals with a small footprint. Depending on the installation situation and the design of the conductor connection terminal, the available connection space for laying and connecting the electrical conductors may be very limited. This may limit the accessibility of the connection area of the conductor connection terminal. Furthermore, as a result of the limited space available, there can be an unfavorable laying situation of a connected electrical conductor, which is associated with bending or buckling of the conductor, for example.

### SUMMARY OF THE INVENTION

It is therefore an object of the invention to create an improved conductor connection terminal and a busbar structure for such conductor connection terminals. In particular, it is intended to facilitate the handling of the conductor connection terminal and improve the connection conditions for conductors to be connected.

In an example, it is provided that the first housing section of the conductor connection terminal can be swiveled relative to the second housing section, and the conductor connection terminal has a busbar structure for the electrically conductive connection of the first spring-loaded clamping connection to the second spring-loaded clamping connection, wherein the busbar structure has a first connection section assigned to the first spring-loaded clamping connection, a second connection section assigned to the second spring-loaded clamping connection, and a hinged section connecting the first connection section to the second connection section.

In other words, a conductor connection terminal with a hinged busbar structure is proposed, which allows for or facilitates the pivoting of housing parts of the conductor connection terminal in relation to each other without affecting and/or interrupting the electrical connection between the spring-loaded clamping connections.

This allows for better use of the connection space available for connecting electrical conductors to the conductor connection terminal, especially in confined installation situations. The orientation of the connection areas of the conductor connection terminal can be individually adapted to the spatial conditions at hand. Improved accessibility of the connection areas of the conductor connection terminal is achieved, so that the conductor connection terminal is easier to handle. In addition, conductors to be connected can be laid gently and flexibly, especially without bending or buckling, so that improved connection conditions are provided for the conductors to be connected. Furthermore, in limited space conditions, the overall length of the conductor connection terminal can be advantageously reduced by swiveling the housing sections towards each other.

The conductor connection terminal can be designed in particular as a feedthrough connector and can be set up, for example, to connect two electrical conductors. A connection area of the conductor connection terminal can refer, for example, to a conductor insertion opening of the conductor connection terminal through which the conductor can be guided to a spring-loaded clamping connection of the conductor connection terminal. Alternatively or additionally, the connection area can refer to an actuating element of the conductor connection terminal, for example to an actuating lever with which a spring-loaded clamping connection of the conductor connection terminal can be operated. Accordingly, the conductor connection terminal can be designed as a lever clamp, for example, and have an actuating lever for operating at least one spring-loaded clamping connection of the conductor connection terminal.

A spring-loaded clamping connection can be a conductor connection with a clamping spring, through which a connected electrical conductor can be clamped to a busbar structure by means of spring force. By means of a spring-loaded clamping connection, an electrical conductor can be connected easily and with little effort and securely contacted, as well as released again by an appropriate actuation of the spring-loaded clamping connection.

An insulating material housing can be a housing made of electrically insulating material, such as plastic. The insulating material housing can accommodate the spring-loaded clamping connections and busbar structure in an interior of the insulating material housing and protects them from environmental influences and contact. The insulating material housing may be designed in several parts to facilitate mounting of the conductor connection terminal and/or the swiveling of one housing section relative to the other housing section of the insulating material housing.

A busbar structure can be an electromechanical component made of an electrically conductive material to which an electrical conductor can be clamped by means of a clamping spring of the spring-loaded clamping connection, so that an electrical connection to the busbar structure can be established. For example, the busbar structure can be a metal strip that can be bent in sections, for example, to form an insertion or support section for electrical conductors. The busbar structure can be designed as a multi-part component or as a one-piece component, as explained below. The busbar structure can be completely incorporated into the insulating material housing, so that the busbar structure does not come into contact with the ambient atmosphere or have to be protected from the environment by an additional insulation structure, even if the housing sections are swiveled towards each other. The busbar structure has a first connection section associated with the first spring-loaded clamping connection. This can mean, for example, that the first connection section forms a conductor support surface, a conductor insertion channel and/or a conductor stop for a first conductor to be clamped to the busbar structure by means of the first spring-loaded clamping connection. The busbar structure has a second connection section, which is associated with the second spring-loaded clamping connection. This can mean, for example, that the second connection section forms a conductor support surface, a conductor insertion channel and/or a conductor stop for a second conductor to be clamped to the busbar structure by means of the second spring-loaded clamping connection.

The busbar structure also has a hinged section that runs between the first and second connection sections and connects them electrically. In the broader sense, a hinged section can be understood as a movable connecting structure. The hinged section can enable relative mobility of the first and second connection sections to each other.

The hinged section of the busbar structure can have a sliding contact area. This makes it easy to enable the relative mobility of the first connection section compared to the second connection section, and vice versa. For example, the first connection section and the second connection section can be movable in relation to each other, wherein they can slide onto each other in the sliding contact area when they move relative to each other, so that essentially a sliding contact can occur between the first and second connection sections. For example, the busbar structure can be designed in two parts, so that the first connection section forms a first busbar component and the second connection section forms a second busbar component, with the first and second busbar sections being movable to each other in the sliding contact area. In other words, the hinged section can form a sliding joint for the first and second connection sections. The sliding contact area can enable a translational or a rotational or a combined translational and rotational sliding movement of the connecting sections on top of each other.

A conductor connection terminal is conceivable in which the hinged section can be changed in length, e.g., is telescopically extendable when the sliding contact area is designed for translational sliding movement. The first and second sections of the housing can be connected to each other with a swivel joint that can be adjusted in length. It is also conceivable that the first and/or second housing section can be changed in length, which are connected to each other via a swivel joint.

The hinged section of the busbar structure can have a lower bending stiffness than the connection sections of the busbar structure. This enables a high and versatile relative mobility of the connection sections to each other. In other words, the hinged section can form a flexible joint between the comparatively stiffer connection sections. As a hinged section with a lower bending stiffness, the hinged section may allow for the formation of at least one bending or buckling point of the busbar structure between the connection sections, wherein such a bending or buckling point may, for example, form a swivel axis for swiveling the second connection section with respect to the first, or vice versa. For example, a hinged section with a lower bending stiffness can be achieved by using a flexible metal strip, such as copper tape, a cross-section reduction of the busbar structure, such as a reduction in sheet thickness, or a softer metal alloy than provided in the connection sections. A flexible metal strip can be accompanied by a very much reduced bending stiffness and form a flexible hinged section that does not have a pronounced bending or buckling point but can be flexibly deformed in its entirety. A connection section with a higher bending stiffness as compared to the hinged section, on the other hand, can ensure that the electrical conductor is safely guided and clamped in the connection section.

The hinged section can be designed as an elastic hinged section, for example have a joint spring, so that the hinged section is elastically pre-tensioned from a starting position when the connection sections move relative to each other and returns to the starting position when a mechanical lock is released, for example. This avoids plastic deformation of the hinged section and achieves a long service life of the busbar structure even with frequent use.

The busbar structure can be designed in one piece. In other words, the busbar structure can be a continuous, monolithic component in which the connection sections merge directly into the hinged section. This can provide a stable, easy-to-assemble busbar structure with high electrical conductivity.

The busbar structure can have a first and a second fastening tab, wherein a clamping spring of the first spring-loaded clamping connection is suspended from the busbar structure by means of the first fastening tab, and a clamping spring of the second spring-loaded clamping connection is suspended from the busbar structure by means of the second fastening tab. This allows for the clamping springs to be easily attached to the busbar structure. For example, the fastening tabs can each have a mounting opening into which an attachment leg of the respective clamping spring can be inserted.

The first connection section and/or the second connection section can have a conductor support surface and a conductor receiving pocket adjacent to the conductor support surface. This ensures that an electrical conductor can be connected securely and without damaging the conductor. The conductor support surface can be a flat material tongue. The conductor support surface can be used to guide and support a conductor that is to be clamped or has been clamped. The conductor receiving pocket can be directly attached to the conductor support surface. The conductor support surface can merge into the conductor receiving pocket at an incline so that a conductor guided on the conductor support surface can project into the conductor receiving pocket at a predefined angle. The conductor receiving pocket can form a holding space for the end section of a clamped conductor and protectively surround it from several sides. For example, the busbar structure can form a round or square, for example rectangular, channel with open end faces in the area of the conductor receiving pocket, which can have a tapered cross-section according to a further development. If the busbar structure is manufactured as a flat sheet metal blank, it can be bent several times in the area of the conductor receiving pocket in order to provide a hollow channel for the conductor end.

The hinged section of the busbar structure can extend between the conductor receiving pockets of the first and second connection sections. The hinged section can be molded directly to the conductor receiving pockets. For example, the hinged section may project from an upper wall of the conductor receiving pocket that is opposite a lower wall adjacent to the conductor support surface. The conductor receiving pockets can safely receive the conductor end of a connected conductor and prevent the conductor from colliding with the hinged section, for example during a swivel operation.

The first housing section and the second housing section can be swiveled to each other via a swivel joint. This makes it easy to swivel the housing sections in relation to each other. The swivel joint can be designed as a hinge joint, for example. The first housing section and the second housing section can form two separate housing components connected by the swivel joint. This can help to ensure that the insulating material housing complies with any standardized dielectric strengths.

The swivel joint can have a swivel arm that can be swiveled about a swivel axis, via which the first housing section and the second housing section are connected to each other. According to a further development, the swivel joint can also have two swivel arms arranged opposite each other for increased stability, which can be swiveled about a common swivel axis.

The first housing section can have a swivel head and the second housing section can have a swivel bearing corresponding to the swivel head, or vice versa. For example, the swivel bearing can have an outer contour that forms a negative shape of the outer contour of the swivel head. For example, the swivel head can have a convex semi-cylindrical profile and the swivel bearing a corresponding concave profile with a semi-cylindrical negative shape. When the housing sections are swiveled, the swivel head can slide down on the swivel bearing in a defined manner and facilitate swiveling.

The first housing section and the second housing section can be arranged overlapping each other in the area of the swivel joint. This ensures that the insulating material housing is sufficiently tight even when the housing sections are swiveled in relation to each other and that any creepage and clearance distances specified by the standards are observed. In the case of an overlapping arrangement, at least one housing wall of one housing section can overlap a housing wall of the other housing section in such a way that the housing sections can be swiveled to each other without gaps.

A swivel angle between 0° and +/−90° can be adjustable between the first housing section and the second housing section. This allows for a wide range of swivel angles to be covered and a conductor connection terminal with optimized space utilization to be provided. For example, a maximum swivel angle may be limited by a stop on a housing section or on a swivel arm to prevent exceeding a designated swivel angle range and to ensure sufficient tightness of the insulating material housing in any swivel state. The swivel angle specified as +/−90° can refer to a swivel angle of 90° in two opposite swivel directions, starting from a 0° starting position. For example, the swivel angle can be clamped between the central longitudinal axes of the first and second housing sections, wherein the central longitudinal axis can be a central axis of the respective housing section, which is essentially aligned with the conductor insertion direction of the spring-loaded clamping connection.

A swivel angle that can be adjusted between the first housing section and the second housing section can be fixable by means of a detent mechanism. This reliably prevents unintentional swiveling of the housing sections, for example when an electrical conductor is connected or due to environmental influences. In addition, the adjustable swivel angle can be limited and predefined fixable swivel angles can be specified. The detent mechanism can be realized, for example, by a detent structure such as a detent tab on one housing section and by detent openings into which the detent tab can be inserted on the other housing section. The detent mechanism can be set up to again loosen a detent connection that has been established if necessary, for example by means of an acting minimum force or a release element.

The detent mechanism may be formed by a detent structure in a swivel arm and by one or more detent openings in the housing section through which the swivel axis of the swivel arm passes. This means that the detent mechanism can be easily implemented and used intuitively. The detent structure in the swivel arm can be, for example, a detent tab, which can be relocated between detent openings in the housing section by applying force. If two swivel arms are provided on the conductor connection terminal, a detent structure may be arranged on only one or both swivel arms, and one or more detent openings may be provided on the housing sides of the housing section facing the swivel arms.

The busbar structure for the electrically conductive connection of the first spring-loaded clamping connection to the second spring-loaded clamping connection has a first connection section, a second connection section, and a hinged section connecting the first connection section to the second connection section. With the proposed busbar structure, it is possible to securely and reliably electrically interconnect spring-loaded clamping connections of a conductor connection terminal that can move relative to each other and to achieve a high degree of design freedom in the individual orientation of the spring-loaded clamping connections of the conductor connection terminal.

According to examples of the busbar structure: the hinged section of the busbar structure can have a sliding contact area; the hinged section of the busbar structure can have a lower bending stiffness than the connection sections of the busbar structure; the hinged section can be designed as an elastic hinged section; the busbar structure can be one piece; the busbar structure can have a first fastening tab for the suspension of a first clamping spring on the busbar structure and a second fastening tab for the suspension of a second clamping spring on the busbar structure; the first connection section and/or the second connection section can have a conductor support surface and a conductor receiving pocket adjacent to the conductor support surface; or the hinged section of the busbar structure can extend between the conductor receiving pockets of the first and second connection sections.

The busbar structure can be made of a flat sheet metal cut. This enables a simple and cost-effective production of the busbar structure. For example, the busbar structure can be obtained by punching out a defined two-dimensional geometric contour from a sheet metal semi-finished product and by bending predetermined positions of the sheet metal strip in different spatial directions, so that the three-dimensional busbar structure can be produced from an essentially two-dimensional sheet metal cut. In this case, bent sections of the busbar structure can be connected to each other, for example, by means of a form-fitting tab structure, for example to form a conductor receiving pocket in accordance with the features described above.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIGS. 1a and 1b show a conductor connection terminal according to an example in lateral sectional views in an initial state and with housing sections swiveled towards each other;

FIGS. 2a and 2b show the conductor connection terminal in accordance with FIGS. 1a and 1b in plan views;

FIGS. 3a and 3b show the conductor connection terminal in accordance with FIGS. 1a and 1b in side views;

FIGS. 4a and 4b show the conductor connection terminal in accordance with FIGS. 1a/1b in perspective side views; and

FIGS. 5a and 5b show a busbar structure for a conductor connection terminal according to an example in perspective side views in an initial state and with connection sections swiveled towards each other.

### DETAILED DESCRIPTION

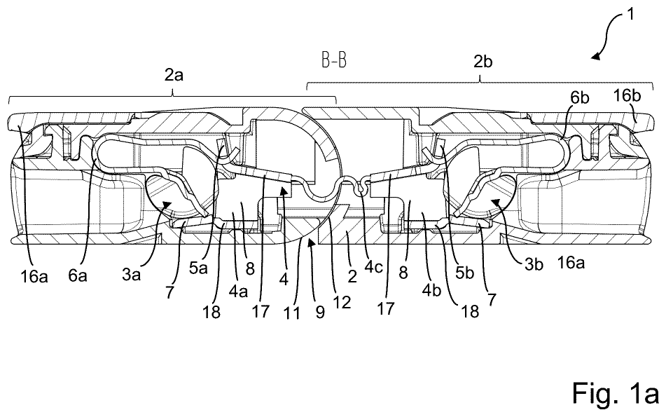

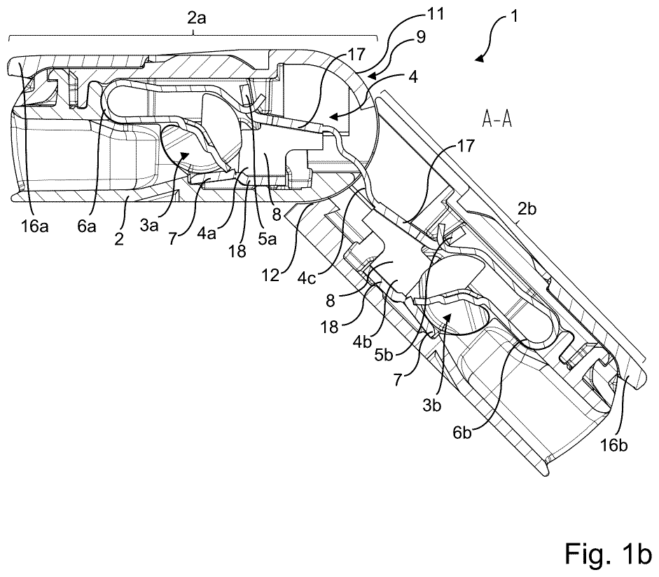

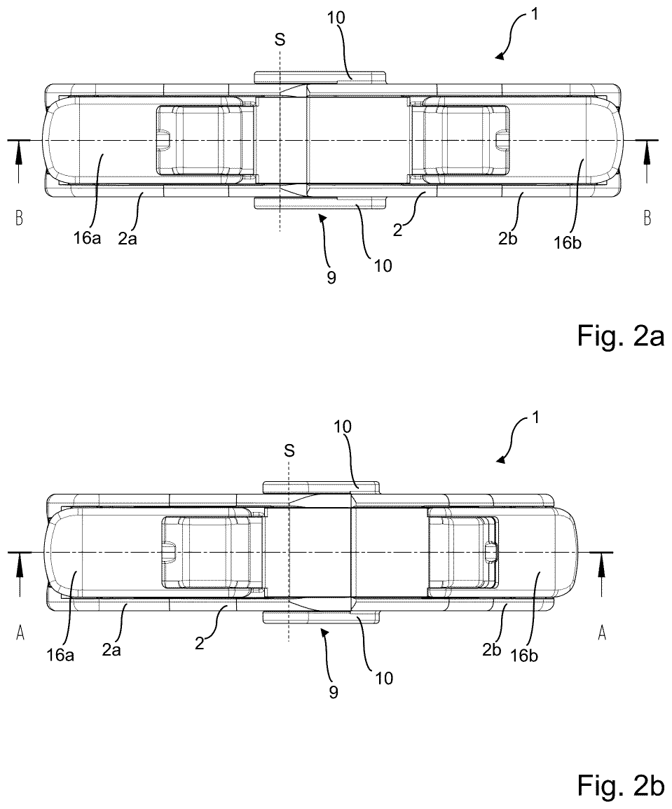

FIGS. 1a and 1b show a conductor connection terminal 1 according to an example in lateral sectional views. In FIG. 1a, the conductor connection terminal 1 is shown in an initial state. FIG. 1b shows the conductor connection terminal 1 with housing sections 2a, 2b swiveled towards each other. FIG. 1a corresponds to a sectional view along the section line B-B shown in FIG. 2a. FIG. 1b corresponds to a sectional view along the section line A-A shown in FIG. 2b.

The conductor connection terminal 1 is used for the electrical connection of electrical conductors that are not specified in detail, which can be connected to the conductor connection terminal 1 via spring-loaded clamping connections 3a, 3b. According to the example shown, the conductor connection terminal 1 is designed as a feedthrough connector. The conductor connection terminal 1 has an insulating material housing 2 with a first housing section 2a and a second housing section 2b. The second housing section 2b can be swiveled relative to the first housing section 2a. In the first housing section 2a, a first spring-loaded clamping connection 3a is arranged. In the second housing section 2b, a second spring-loaded clamping connection 3b is arranged. According to the example shown, the conductor connection terminal 1 is designed as a lever clamp and has a first actuating lever 16a for actuating a clamping spring 6a of the first spring-loaded clamping connection 3a and a second actuating lever 16b for actuating a clamping spring 6b of the second spring-loaded clamping connection 3b.

The conductor connection terminal 1 has a busbar structure 4 for the electrically conductive connection of the first spring-loaded clamping connection 3a with the second spring-loaded clamping connection 3b. A first connection section 4a of the busbar structure 4 is assigned to the first spring-loaded clamping connection 3a. A second connection section 4b of the busbar structure 4 is assigned to the second spring-loaded clamping connection 3b. The first connection section 4a and the second connection section 4b of the busbar structure 4 are connected to each other by a hinged section 4c. The hinged section 4c allows for the first connection section 4a and the second connection section 4b to move relative to each other and thus allows the housing sections 2a, 2b to swivel towards each other without affecting and/or interrupting the electrical connection between the spring-loaded clamping connections 3a, 3b. Due to the swiveling of the housing sections 2a, 2b and the adapted busbar structure 4, the connection space available for connecting electrical conductors to the conductor connection terminal 1 can be better utilized, especially in confined installation situations.

As indicated in FIGS. 1a and 1b, the hinged section 4c of the busbar structure 4, according to the example shown, is designed as a flexible pipe run made of an electrically conductive material and therefore has a lower bending stiffness than the connection sections 4a, 4b of the busbar structure 4. This way, the connection sections 4a, 4b can achieve a high relative mobility to one another. The hinged section 4c, the first connection section 4a, and the second connection section 4b are formed in one piece according to the example shown, so that the connection sections 4a, 4b merge directly into the hinged section 4c. In this case, the hinged section 4c can be connected to connection sections 4a and 4b in a material-tight manner. The hinged section 4c can be molded together with the connection sections 4a, 4b from a single piece of material or molded to the connection sections 4a, 4b in a material-tight manner. This ensures high electrical conductivity. Further, the busbar structure 4 can, for example, also be designed in two parts and have a sliding contact area for the realization of a sliding contact between the first connection section 4a and the second connection section 4b.

As shown in FIGS. 1a and 1b, the clamping spring 6a of the first spring-loaded clamping connection 3a can be suspended from the busbar structure 4 by means of a first fastening tab 5a and the clamping spring 6b of the second spring-loaded clamping connection 3b from the busbar structure 4 by means of a second fastening tab 5b, which makes it easy to attach the busbar structure 4 to the conductor connection terminal 1. In addition, the first connection section 4a and the second connection section 4b each have a conductor support surface 7 in the form of a flat material tongue for guiding and supporting a conductor to be clamped and a conductor receiving pocket 8 adjacent to the conductor support surface 7. The conductor support surface 7 merges into the conductor receiving pocket 8 at an incline, so that a conductor guided on the conductor support surface 7 can project into the conductor receiving pocket 8 at a predefined angle. According to the illustration, the conductor receiving pocket 8 forms a receiving space with a square channel with open ends for an end section of a clamped conductor.

As can be seen from FIGS. 1a and 1b, the hinged section 4c of the busbar structure 4 extends between the conductor receiving pockets 8 of the connection sections 4a, 4b. The hinged section 4c is molded directly to the conductor receiving pockets 8 and projects from an upper wall 17 of the conductor receiving pocket 8, which is opposite a lower wall 18 adjacent to the conductor support surface 7. The conductor receiving pockets 8 can receive the conductor end of a clamped conductor and prevent a collision with the hinged section 4c during a swivel operation.

As shown in FIGS. 1a and 1b, the first housing section 2a and the second housing section 2b are connected to each other by a swivel joint 9. The first housing section 2a and the second housing section 2b form separate housing components that are connected to each other via the swivel joint 9. The first housing section 2a has a swivel head 11 with a convex semi-cylindrical profile and the second housing section has a swivel bearing 12 corresponding to the swivel head 11 with a concave profile with a semi-cylindrical negative shape. When swiveling the housing sections 2a, 2b, the swivel head 11 can slide down on the swivel bearing 12 in a defined manner and make swiveling easier. As can be seen in particular in the cross-sectional representations according to FIGS. 1a and 1b, the first housing section 2a and the second housing section 2b are arranged overlapping each other in the area of the swivel joint 9. The housing wall of the second housing section 2b overlaps the opposite housing wall of the first housing section 2a in the initial position according to FIGS. 1a and 1n the swiveled position according to FIG. 1b, so that gap-free swiveling of the housing sections 2a, 2b in relation to each other is possible. This ensures sufficient tightness, creepage and clearance distances.

FIGS. 2a and 2b show the conductor connection terminal 1 described above in plan views. In FIG. 2a, the conductor connection terminal 1 is shown in an initial state. FIG. 2b shows the conductor connection terminal 1 with housing sections 2a, 2b swiveled towards each other. In these views, the actuating levers 16a, 16b of the spring-loaded clamping connections 3a, 3b, among others, can be seen in a view. As shown and also evident in the following figures, the swivel joint 9 also has two swivel arms 10 that can be swiveled about a common swivel axis S, via which the housing sections 2a, 2b are connected to each other. Furthermore, it can be seen from FIGS. 2a and 2b that by swiveling the housing sections 2a, 2b to each other, the total length of the conductor connection terminal 1 along the cutting lines A-A or B-B can be advantageously reduced, for example for confined installation situations.

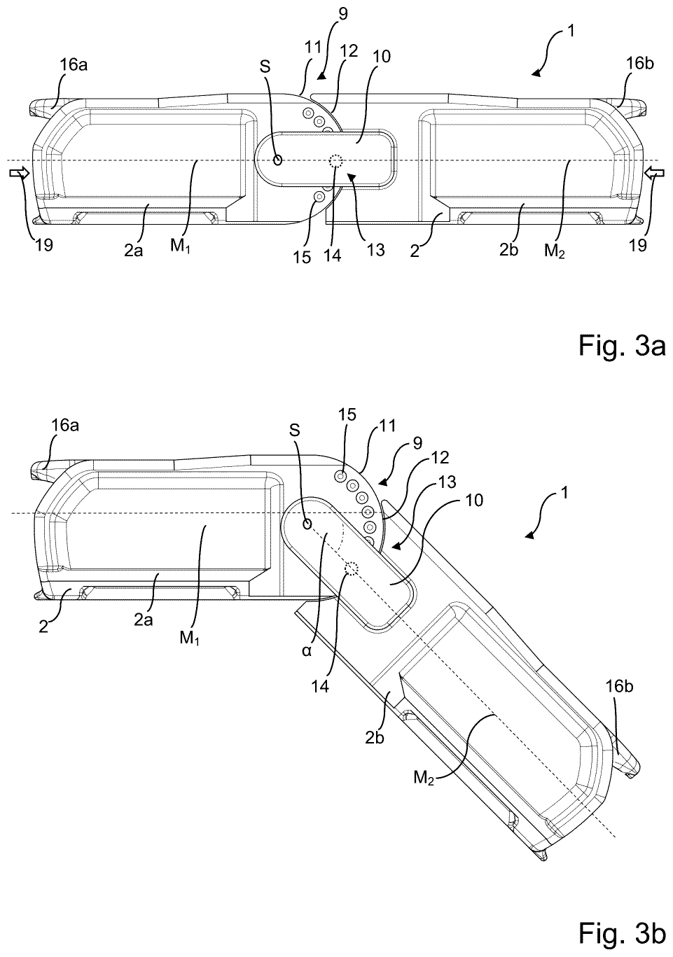

FIGS. 3a and 3b show the conductor connection terminal 1 described above in side views. In FIG. 3a, the conductor connection terminal 1 is shown in an initial state. FIG. 3b shows the conductor connection terminal 1 with housing sections 2a, 2b swiveled towards each other. In these views, one of the two swivel arms 10 can be seen in the side view. Furthermore, it can be seen in these diagrams that between a central longitudinal axis M1 of the first housing section 2a and between a central longitudinal axis M2 of the second housing section 2b no swivel angle α or a swivel angle α of 0° is spanned in the illustration shown in FIG. 3a, and in the illustration shown in FIG. 3b a swivel angle α of about 45° is spanned by way of example. The central longitudinal axes M1 and M2 can be central axes of the respective housing sections 2a, 2b, which are essentially aligned with a respective conductor insertion direction 19 in the conductor connection terminal 1.

As can be seen in FIGS. 3a and 3b, the swivel angle α, which can be adjusted between the first housing section 2a and the second housing section 2b, can be fastened by means of a detent mechanism 13. The detent mechanism 13 is formed by a detent structure 14 indicated in the illustrations, for example a detent tab on which swivel arm 10 and detent openings 15 are formed, into which the detent structure 14 can be immersed. According to the example shown, the detent openings 15 are arranged on the first housing section 2a, through which the swivel axis S of the swivel arms 10 runs. It is optional, and not specified, that the detent mechanism 13 is provided on both sides of the conductor connection terminal 1, on which the swivel arms 10 are arranged.

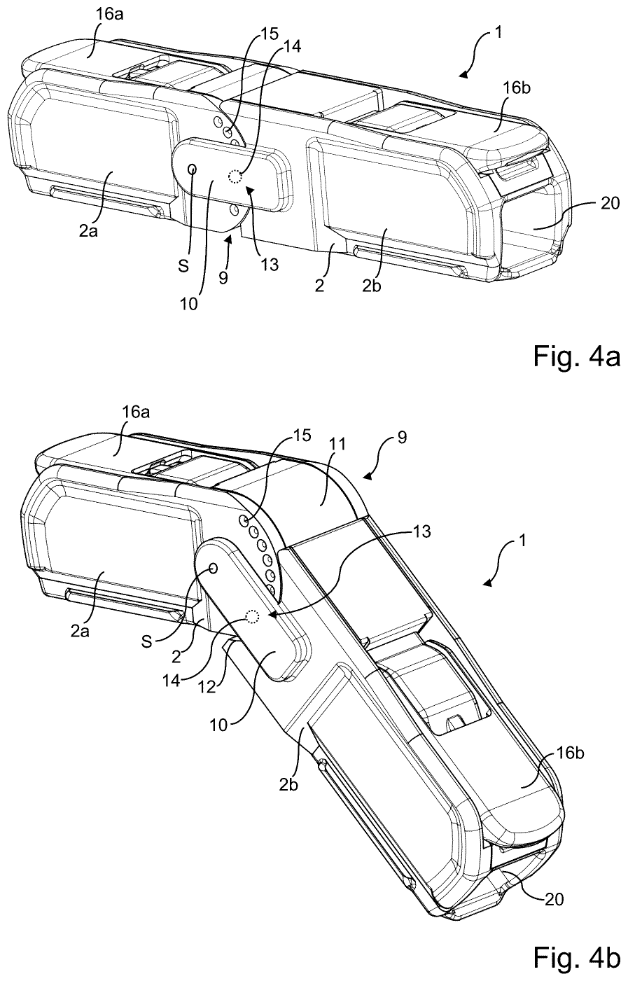

FIGS. 4a and 4b show the conductor connection terminal 1 described above in perspective side views. In FIG. 4a, the conductor connection terminal 1 is shown in an initial state. FIG. 4b shows the conductor connection terminal 1 with housing sections 2a, 2b swiveled towards each other. In these views, the design of the swivel joint 9 with the semi-cylindrical swivel head 11 and the corresponding concave profile of the swivel bearing 12 with a semi-cylindrical negative shape is further illustrated. In addition, it can be seen that the housing sections 2a, 2b have a conductor insertion opening 20, through which an electrical conductor to be connected can be routed to the respective spring-loaded clamping connection 3a, 3b of housing section 2a, 2b.

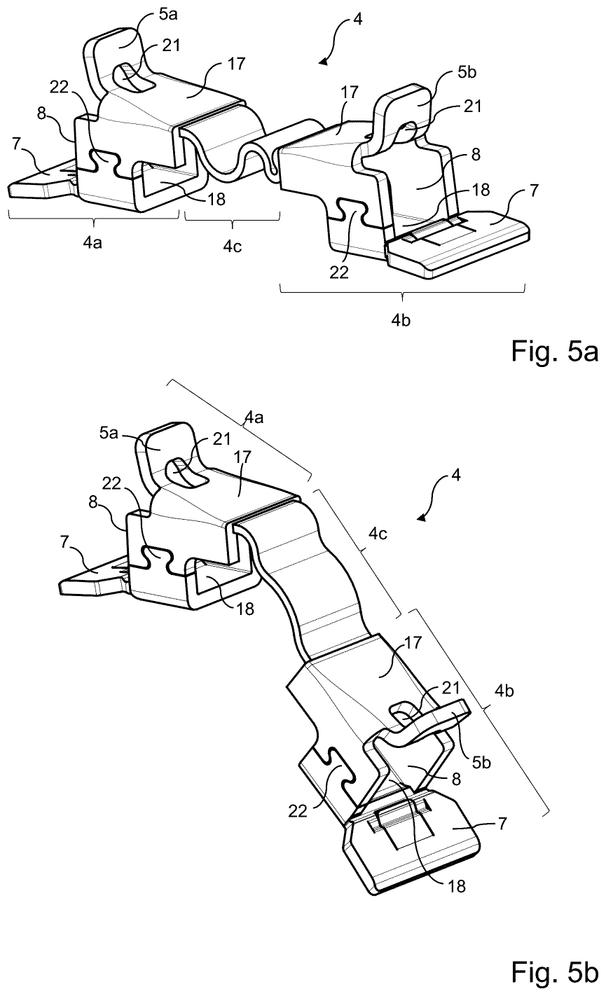

FIGS. 5a and 5b show a busbar structure 4 for the conductor connection terminal 1 described above according to an example in perspective side views. In FIG. 5a, the busbar structure 4 is shown in an initial state. FIG. 5b shows the busbar structure 4 with connection sections 4a, 4b swiveled towards each other. FIGS. 5a and 5b can be considered isolated representations of the busbar structure 4 shown in FIGS. 1a and 1b.

The busbar structure 4 is designed for the electrically conductive connection of spring-loaded clamping connections 3a, 3b and conductors connected thereto and has a first connection section 4a, a second connection section 4b, and a hinged section 4c connecting the first connection section 4a with the second connection section 4b. Due to the hinged section 4c, the connection sections 4a, 4b are movable relative to each other and can therefore securely and reliably connect spring-loaded clamping connections 3a, 3b that are relatively movable to each other. According to the example shown, the hinged section 4c is designed as a flexible pipe run made of an electrically conductive material and therefore has a lower bending stiffness than the connection sections 4a, 4b of the busbar structure 4. The hinged section 4c, the first connection section 4a and the second connection section 4b are formed in one piece according to the exemplary example shown, so that the connection sections 4a, 4b merge directly into the hinged section 4c.

As shown in FIGS. 5a and 5b, the busbar structure 4 may have a first fastening tab 5a for the suspension of the first clamping spring 6a on the busbar structure 4 and a second fastening tab 5b for the suspension of the second clamping spring 6b on the busbar structure 4. For example, the fastening tabs 5a, 5b can each have a mounting opening 21 into which an attachment leg of the respective clamping spring 6a, 6b can be immersed. In addition, the first connection section 4a and the second connection section 4b each have a conductor support surface 7 in the form of a flat material tongue for guiding and supporting a conductor to be clamped and a conductor receiving pocket 8 adjacent to the conductor support surface 7. The conductor support surface 7 merges into the conductor receiving pocket 8 at an incline, so that a conductor guided on the conductor support surface 7 can protrude into the conductor receiving pocket 8 at a predefined angle. According to the illustration, the conductor receiving pocket 8 forms a receiving space with a square channel with open ends for an end section of a clamped conductor.

As can be seen from FIGS. 5a and 5b, the hinged section 4c of the busbar structure 4 extends between the conductor receiving pockets 8 of the connection sections 4a, 4b. The hinged section 4c is molded directly to the conductor receiving pockets 8 and protrudes from an upper wall 17 of the conductor receiving pocket 8, which is opposite a lower wall 18 adjacent to the conductor support surface 7. The conductor receiving pockets 8 can pick up the conductor end of a clamped conductor and prevent a collision with the hinged section 4c during a swivel operation.

Furthermore, when looking at FIGS. 5a, 5b, it can be seen that the busbar structure 4 can be made of a flat sheet metal cut. For example, the busbar structure 4 can be obtained by punching out a defined two-dimensional geometric contour from a sheet metal semi-finished product and by bending at predetermined positions of the sheet metal strip in different spatial directions, so that the three-dimensional busbar structure 4 can be produced from an essentially two-dimensional sheet metal cut. In this case, bent sections of the busbar structure 4 can be connected to each other, for example, by means of a form-fitting tab structure 22, to form a conductor receiving pocket 8 in accordance with the features described above.

With the conductor connection terminal 1 and busbar structure 4 described above, easier handling of the conductor connection terminal 1 and improved connection conditions for conductors to be connected are made possible.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conductor connection terminal to connect electrical conductors to each other, the conductor connection terminal comprising:
an insulating material housing comprising a first housing section with a first spring-loaded clamping connection arranged in the first housing section and comprising a second housing section with a second spring-loaded clamping connection arranged in the second housing section, the first housing section adapted to be swiveled relative to the second housing section; and
a busbar structure for an electrically conductive connection of the first spring-loaded clamping connection with the second spring-loaded clamping connection, the busbar structure comprising a first connection section assigned to the first spring-loaded clamping connection, a second connection section assigned to the second spring-loaded clamping connection, and a hinged section that connects the first connection section with the second connection section.

2. The conductor connection terminal according to claim 1, wherein the busbar structure is designed in one piece.

3. The conductor connection terminal according to claim 1, wherein the hinged section of the busbar structure has a sliding contact area.

4. The conductor connection terminal according to claim 1, wherein the hinged section of the busbar structure has a lower bending stiffness than the connection sections of the busbar structure.

5. The conductor connection terminal according to claim 4, wherein the hinged section is formed as an elastic hinged section.

6. The conductor connection terminal according to claim 1, wherein the busbar structure has a first fastening tab from which a clamping spring of the first spring-loaded clamping connection is suspended, and wherein the busbar structure has a second fastening tab from which a clamping spring of the second spring-loaded clamping connection is suspended.

7. The conductor connection terminal according to claim 1, wherein the first connection section and/or the second connection section have a conductor support surface and a conductor receiving pocket adjacent to the conductor support surface.

8. The conductor connection terminal according to claim 7, wherein the hinged section of the busbar structure extends between the conductor receiving pockets of the first connection section and the second connection section.

9. The conductor connection terminal according to claim 1, wherein the first housing section and the second housing section are connected to each other via a swivel joint so as to swivel.

10. The conductor connection terminal according to claim 9, wherein the swivel joint has at least one swivel arm that is adapted to be swiveled about a swivel axis, via which the first housing section and the second housing section are connected to each other.

11. The conductor connection terminal according to claim 9, wherein the first housing section has a swivel head and the second housing section has a swivel bearing corresponding to the swivel head, or vice versa.

12. The conductor connection terminal according to claim 9, wherein the first housing section and the second housing section are arranged overlapping each other in an area of the swivel joint.

13. The conductor connection terminal according to claim 1, wherein, between the first housing section and the second housing section, a swivel angle is adjustable between 0° and +/−90°.

14. The conductor connection terminal according to claim 13, wherein the swivel angle adjustable between the first housing section and the second housing section is fixable via a detent.

15. The conductor connection terminal according to claim 14, wherein the detent is formed by a detent structure in a swivel arm and by one or more detent openings in the housing section through which the swivel axis of the swivel arm passes.
